(19) United States
(12) Patent Application Publication
(10) Pub. No.: US 2025/0014792 A1
(43) Pub. Date: Jan. 9, 2025

(54) R-T-B BASED PERMANENT MAGNET

(71) Applicant: TDK CORPORATION, Tokyo (JP)

(72) Inventors: Hiroki KAWAMURA, Tokyo (JP); Hikaru KUDO, Tokyo (JP); Masashi MIWA, Tokyo (JP)

(73) Assignee: TDK CORPORATION, Tokyo (JP)

(21) Appl. No.: 18/702,173

(22) PCT Filed: Nov. 2, 2022
(86) PCT No.: PCT/JP2022/041055

§ 371 Date: Apr. 17, 2024

(30) Foreign Application Priority Data
Nov. 5, 2021 (JP) 2021-181081

(51) Int. Cl. H01F 1/057

(52) U.S. Cl. CPC H01F 1/057; H01F 1/0576; H01F 1/0577

(57) ABSTRACT

An R-T-B based permanent magnet contains Al, Ga, and Zr. The R content is greater than or equal to 30.00 mass % and less than or equal to 33.00 mass %, the B content is greater than or equal to 0.70 mass % and less than or equal to 0.88 mass %, the Al content is greater than 0 mass % and less than or equal to 0.07 mass %, the Ga content is greater than or equal to 0.40 mass % and less than or equal to 1.00 mass %, and the Zr content is greater than 0.10 mass % and less than or equal to 1.60 mass %.

### TECHNICAL FIELD

The present disclosure relates to an R-T-B based permanent magnet.

### BACKGROUND

Patent Document 1 describes an invention related to an R—Fe—B base sintered magnet having high coercivity (HcJ) at high temperatures by having a specific composition and a specific microstructure.

Patent Document 2 describes an invention related to an R—(Fe,Co)—B base sintered magnet having high HcJ at room temperature and at high temperatures by having a specific composition and a specific microstructure.
Patent Document 1: JP Patent Application Laid Open No. 2017-228771
Patent Document 2: JP Patent Application Laid Open No. 2018-82040

### SUMMARY

It is an object of the present disclosure to provide an R-T-B based permanent magnet having an improved residual flux density (Br) at room temperature and an improved HcJ at high temperatures in a well-balanced manner.

To achieve the above object, an R-T-B based permanent magnet according to the present disclosure is
an R-T-B based permanent magnet including Al, Ga, and Zr and having
an R content of 30.00 mass % or more and 33.00 mass % or less,
a B content of 0.70 mass % or more and 0.88 mass % or less,
an Al content of above 0 mass % and 0.07 mass % or less,
a Ga content of 0.40 mass % or more and 1.00 mass % or less, and
a Zr content of above 0.10 mass % and 1.60 mass % or less,
out of 100 mass % of the R-T-B based permanent magnet.

The R-T-B based permanent magnet may have a Co content of 0.50 mass % or more and 3.00 mass % or less.

The R-T-B based permanent magnet may have a Cu content of 0.15 mass % or more and 1.00 mass % or less.

The R-T-B based permanent magnet may have a C content of 0.05 mass % or more and 0.30 mass % or less.

The R-T-B based permanent magnet may have a heavy rare earth element content of 0 mass % or more and 0.30 mass % or less.

The R-T-B based permanent magnet may satisfy Br_{L}+ (HcJ_{H}/3)≥1580, where Br_{L} (mT) denotes a residual flux density of the R-T-B based permanent magnet at room temperature and HcJ_{H} (kA/m) denotes a coercivity of the R-T-B based permanent magnet at 150° C.

### DETAILED DESCRIPTION

Hereinafter, the present disclosure is described based on an embodiment.

An R-T-B based permanent magnet contains Al, Ga, and Zr. Out of 100 mass % of the R-T-B based permanent magnet, the R-T-B based permanent magnet has an “R” content of 30.00 mass % or more and 33.00 mass % or less, a B content of 0.70 mass % or more and 0.88 mass % or less, an Al content of above 0 mass % and 0.07 mass % or less, a Ga content of 0.40 mass % or more and 1.00 mass % or less, and a Zr content of above 0.10 mass % and 1.60 mass % or less.

Having the above composition, the R-T-B based permanent magnet can have an improved Br at room temperature and an improved HcJ at high temperatures in a well-balanced manner.

“R” of the R-T-B based permanent magnet represents a rare earth element. “T” of the R-T-B based permanent magnet represents an iron group element. “B” of the R-T-B based permanent magnet represents boron. The R-T-B based permanent magnet is a permanent magnet containing at least one rare earth element, at least one iron group element, and boron. An iron group element is a general term for Fe, Co, or Ni. The R-T-B based permanent magnet includes main phase grains having an R₂T₁₄B type crystal structure.

Regarding the at least one rare earth element, the “R” content, i.e., the rare earth element content, is 30.00 mass % or more and 33.00 mass % or less. The rare earth element content may be 30.00 mass % or more and 32.00 mass % or less. When the rare earth element content is 30.00 mass % or more and 32.00 mass % or less, Br at room temperature is improved more easily than when the rare earth element content exceeds 32.00 mass %. When the “R” content is too low, HcJ at high temperatures is easily reduced. When the “R” content is too high, abnormal grain growth easily occurs, and Br at room temperature is easily reduced. The R-T-B based permanent magnet may substantially contain only at least one selected from the group consisting of Nd, Pr, Dy, and Tb as the at least one rare earth element or may substantially contain only at least one selected from the group consisting of Nd and Pr as the at least one rare earth element. The phrase “substantially contain only at least one selected from the group consisting of Nd, Pr, Dy, and Tb as the at least one rare earth element” means that the content of rare earth elements other than Nd, Pr, Dy, and Tb of the R-T-B based permanent magnet is 0.01 mass % or less in total. The phrase “substantially contain only at least one selected from the group consisting of Nd and Pr as the at least one rare earth element” means that the content of rare earth elements other than Nd and Pr of the R-T-B based permanent magnet is 0.01 mass % or less in total.

Regarding the at least one rare earth element, the heavy rare earth element content may be 0 mass % or more and 0.80 mass % or less, 0 mass % or more and 0.50 mass % or less, or 0 mass % or more and 0.30 mass % or less to reduce raw material costs.

Among rare earth elements, Gd, Tb, Dy, Ho, Er, Tm, Yb, and Lu are classified as heavy rare earth elements.

Regarding the at least one iron group element, the R-T-B based permanent magnet may indispensably contain Fe or may indispensably contain Fe and Co. When the R-T-B based permanent magnet contains Fe and Co, the Co content is not limited. However, in terms of improving magnetic properties and corrosion resistance, the Co content may be 0.50 mass % or more and 3.00 mass % or less or may be 0.80 mass % or more and 3.00 mass % or less. The R-T-B based permanent magnet may substantially not contain Ni. Specifically, the Ni content may be less than 0.01 mass %.

The B content is 0.70 mass % or more and 0.88 mass % or less. The B content may be 0.70 mass % or more and 0.83 mass % or less. When the B content is too low, sintering tends to be insufficient. As a result, Br at room temperature and HcJ at high temperatures are easily reduced. When the B content is too high, HcJ at high temperatures is easily reduced.

The Al content is above 0 mass % and 0.07 mass % or less. The Al content may be 0.02 mass % or more and 0.07 mass % or less. When Al is not contained, HcJ at high temperatures is reduced. When the Al content is too high, Br at room temperature is reduced.

The Ga content is 0.40 mass % or more and 1.00 mass % or less. The Ga content may be 0.40 mass % or more and 0.80 mass % or less. When the Ga content is 0.40 mass % or more and 0.80 mass % or less, Br at room temperature is improved more easily than when the Ga content exceeds 0.80 mass %. When the Ga content is too low, HcJ at high temperatures is easily reduced. When the Ga content is too high, Br at room temperature is easily reduced.

The Zr content is above 0.10 mass % and 1.60 mass % or less. The Zr content may be 0.15 mass % or more and 1.50 mass % or less, 0.35 mass % or more and 1.30 mass % or less, or 0.35 mass % or more and 0.95 mass % or less. When importance is attached to high HcJ at high temperatures, the Zr content may be 0.50 mass % or more and 1.50 mass % or less. When the Zr content is too low, grain growth of magnetic grains included in the R-T-B based permanent magnet easily occurs. As a result, HcJ at high temperatures is easily reduced. When the Zr content is too high, sintering tends to be insufficient. As a result, Br at room temperature and HcJ at high temperatures are easily reduced.

The R-T-B based permanent magnet may contain Cu as necessary or may not contain Cu. When Cu is contained, the Cu content may be 0.15 mass % or more and 1.00 mass % or less. With a Cu content of 0.15 mass % or more and 1.00 mass % or less, Br at room temperature and HcJ at high temperatures are further easily improved in a well-balanced manner.

The Cu content may be 0.15 mass % or more and 0.30 mass % or less. When the Cu content is 0.15 mass % or more and 0.30 mass % or less, HcJ at high temperatures is improved more easily than when the Cu content exceeds 0.30 mass %.

The R-T-B based permanent magnet may contain O, N, and/or C as necessary or may not contain O, N, and/or C.

When O is contained, the O content may be 0 mass % or more and 0.20 mass % or less.

When N is contained, the N content may be 0 mass % or more and 0.10 mass % or less.

When C is contained, the C content may be 0.05 mass % or more and 0.30 mass % or less or may be 0.09 mass % or more and 0.26 mass % or less. With a C content within the above range, Br at room temperature and HcJ at high temperatures are further easily improved in a well-balanced manner.

“Out of 100 mass % of the R-T-B based permanent magnet” means that the total content of all elements is 100 mass %. The Fe content of the R-T-B based permanent magnet may substantially be a balance of the R-T-B based permanent magnet. Specifically, the total content of elements other than the above elements, i.e., the total content of elements other than rare earth elements, Fe, Co, Ni, B, Al, Ga, Zr, Cu, O, N, and C, may be 0.50 mass % or less.

### <Method of Manufacturing R-T-B Based Permanent Magnet>

Hereinafter, an example method of manufacturing the R-T-B based permanent magnet according to the present embodiment is described. The method of manufacturing the R-T-B based permanent magnet (R-T-B based sintered magnet) according to the present embodiment includes the following steps. Note that steps (g) to (i) below may be omitted.
(a) an alloy preparation step of producing a raw material alloy
(b) a pulverization step of pulverizing the raw material alloy
(c) a pressing step of pressing a resultant alloy powder
(d) a sintering step of sintering a resultant green compact to provide the R-T-B based permanent magnet
(e) an aging treatment step of age-treating the R-T-B based permanent magnet
(f) a cooling step of cooling the R-T-B based permanent magnet
(g) a machining step of machining the R-T-B based permanent magnet
(h) a grain boundary diffusion step of diffusing a heavy rare earth element or elements to grain boundaries of the R-T-B based permanent magnet
(i) a surface treatment step of surface-treating the R-T-B based permanent magnet

### [Alloy Preparation Step]

First, a raw material alloy is prepared (alloy preparation step). A strip casting method is described below as an example method of preparing the alloy, but methods of preparing the alloy are not limited to the strip casting method.

First, raw material metals corresponding to the composition of the raw material alloy are prepared and are melted in a vacuum or an inert gas (e.g., Ar gas) atmosphere. Then, the molten raw material metals are casted to produce the raw material alloy. Note that, while a one-alloy method is described in the present embodiment, a two-alloy method may be used, in which two alloys, namely a first alloy and a second alloy, are mixed to produce the raw material alloy.

The raw material metals may be of any type. For example, rare earth metals, rare earth alloys, pure iron, pure cobalt, ferro-boron, their alloys, or their compounds can be used. Casting methods of casting the raw material metals are not limited. Examples of casting methods include an ingot casting method, the strip casting method, a book molding method, and a centrifugal casting method. The resultant raw material alloy may be subject to a homogenization treatment (solution treatment) as necessary when the raw material alloy has a solidification segregation.

### [Pulverization Step]

After the raw material alloy is produced, the raw material alloy is pulverized (pulverization step). The pulverization step may be carried out using a two-step process, which includes a coarse pulverization step of pulverizing the raw material alloy to a particle size of about several hundred μm to about several mm and a fine pulverization step of finely pulverizing a coarsely pulverized powder to a particle size of about several μm. However, a one-step process consisting solely of the fine pulverization step may be carried out.

### (Coarse Pulverization Step)

The raw material alloy is coarsely pulverized until it has a particle size of about several hundred μm to about several mm (coarse pulverization step). This provides the coarsely pulverized powder of the raw material alloy. Coarse pulverization may be carried out using, for example, hydrogen storage pulverization. Hydrogen storage pulverization can be performed by making the raw material alloy store hydrogen and then release hydrogen based on difference in the amount of stored hydrogen between different phases to bring self-collapsing pulverization. Release of hydrogen based on difference in the amount of stored hydrogen between different phases is referred to as dehydrogenation. Dehydrogenation conditions are not limited. Dehydrogenation is carried out, for example, at 300 to 650° C. in an argon flow or a vacuum.

Coarse pulverization methods are not limited to the above-mentioned hydrogen storage pulverization. For example, coarse pulverization may be carried out using coarse pulverizers, such as a stamp mill, a jaw crusher, or a brown mill, in an inert gas atmosphere.

For the R-T-B based permanent magnet to have high magnetic properties, an atmosphere of each step from the coarse pulverization step to the sintering step described later may be an atmosphere with a low oxygen concentration. The oxygen concentration is adjusted by, for example, control of the atmosphere of each manufacturing step. When the oxygen concentration of each manufacturing step is high, a rare earth element in the alloy powder resulting from pulverizing the raw material alloy is oxidized to generate rare earth element oxide. The rare earth element oxide is not reduced during sintering and is deposited in the grain boundaries in the form of the rare earth element oxide. The grain boundaries are portions between two or more of the main phase grains. As a result, Br of the resultant R-T-B based permanent magnet is reduced. Thus, for example, each step (fine pulverization step, pressing step) may be carried out in an atmosphere having an oxygen concentration of 100 ppm or less.

### (Fine Pulverization Step)

After the raw material alloy is coarsely pulverized, the resultant coarsely pulverized powder of the raw material alloy is finely pulverized until the powder has an average particle size of about several μm (fine pulverization step). This provides a finely pulverized powder of the raw material alloy. Finely pulverizing the coarsely pulverized powder can provide the finely pulverized powder. D50 of the particles included in the finely pulverized powder is not limited. For example, D50 may be 2.0 μm or more and 4.5 μm or less or may be 2.5 μm or more and 3.5 μm or less. The smaller the D50, the more easily HcJ of the R-T-B based permanent magnet according to the present embodiment is improved. However, abnormal grain growth easily occurs during the sintering step, reducing the upper limit of the sintering temperature range. The larger the D50, the less easily abnormal grain growth occurs during the sintering step, increasing the upper limit of the sintering temperature range. However, HcJ of the R-T-B based permanent magnet according to the present embodiment is easily reduced.

Fine pulverization is carried out by further pulverizing the coarsely pulverized powder using a fine pulverizer, such as a jet mill, ball mill, vibrating mill, or wet attritor, while conditions such as pulverization time and the like are adjusted as appropriate. A jet mill is described below. A jet mill is a fine pulverizer in which a high-pressure inert gas (e.g., He gas, N₂ gas, or Ar gas) is released from a narrow nozzle to generate a high-speed gas flow, which accelerates the coarsely pulverized powder of the raw material alloy to collide against each other or collide with a target or a container wall for pulverization.

When the coarsely pulverized powder of the raw material alloy is finely pulverized, a pulverization aid may be added. The pulverization aid may be of any type. For example, an organic lubricant or a solid lubricant may be used. Examples of organic lubricants include oleic amide, lauramide, and zinc stearate. Examples of solid lubricants include graphite. Adding the pulverization aid can provide the finely pulverized powder such that orientation is easily generated when a magnetic field is applied in the pressing step. Either an organic lubricant or a solid lubricant may be used, or both of them may be mixed and used. This is because, particularly when only a solid lubricant is used, degree of orientation may be reduced.

### [Pressing Step]

The finely pulverized powder is pressed into an intended shape (pressing step). In the pressing step, a mold disposed in an electromagnet is filled with the finely pulverized powder, and the powder is pressed, to provide a green compact. At this time, pressing the finely pulverized powder while a magnetic field is being applied allows a crystal axis of the finely pulverized powder to be oriented in a specific direction. Because the resultant green compact is oriented in the specific direction, the R-T-B based permanent magnet has higher magnetic anisotropy. A pressing aid may be added. The pressing aid may be of any type. The same lubricant as the pulverization aid may be used. The pulverization aid may double as the pressing aid.

The pressure applied during pressing may be, for example, 30 MPa or more and 300 MPa or less. The magnetic field applied may be, for example, 1000 kA/m or more and 1600 kA/m or less. The magnetic field applied is not limited to a static magnetic field and can be a pulsed magnetic field. A static magnetic field and a pulsed magnetic field can be used together.

As for a pressing method, other than dry pressing, in which the finely pulverized powder is directly pressed as described above, wet pressing can be used, in which a slurry including the finely pulverized powder dispersed in a solvent (e.g., oil) is pressed.

The green compact resulting from pressing the finely pulverized powder may have any shape according to a desired shape of the R-T-B based permanent magnet. For example, the green compact can have a rectangular parallelepiped shape, a plate shape, a columnar shape, or a ring shape.

### [Sintering Step]

The green compact resulting from pressing the finely pulverized powder into an intended shape in a magnetic field is sintered in a vacuum or an inert gas atmosphere to provide the R-T-B based permanent magnet (sintering step). The holding temperature and the holding time during sintering need to be adjusted according to conditions, such as a composition (mainly the B content), a pulverization method, and a difference in particle size and particle size distribution. The holding temperature may be, for example, 1000° C. or more and 1100° C. or less, or 1020° C. or more and 1070° C. or less. The holding time is not limited and may be, for example, 2 hours or more and 50 hours or less, or 4 hours or more and 40 hours or less. The shorter the holding time, the higher the production efficiency. The holding atmosphere is not limited. For example, an inert gas atmosphere, a less than 100 Pa vacuum atmosphere, or a less than 10 Pa vacuum atmosphere may be used. The heating rate to reach the holding temperature is not limited. Through sintering, the green compact undergoes liquid phase sintering to provide the R-T-B based permanent magnet according to the present embodiment. The cooling rate after the green compact is sintered to provide the sintered body is not limited. For higher production efficiency, the sintered body may be rapidly cooled. The sintered body may be rapidly cooled at 30° C./min or higher.

### [Aging Treatment Step]

After the green compact is sintered, the R-T-B based permanent magnet is age-treated (aging treatment step). After sintering, the resultant R-T-B based permanent magnet is, for example, held at a temperature lower than the sintering temperature to perform an aging treatment of the R-T-B based permanent magnet. Description of the aging treatment performed in two stages, which are a first aging treatment and a second aging treatment, is provided below. However, only either one of them may be performed, or the aging treatment in three or more stages may be performed.

The holding time and the holding temperature of each aging treatment are not limited. For example, the first aging treatment may be performed at a holding temperature of 800° C. or more and 900° C. or less for 30 minutes or more and 4 hours or less. The heating rate to reach the holding temperature may be 5° C./min or higher and 50° C./min or lower. The atmosphere of the first aging treatment may be an inert gas atmosphere (e.g., He gas or Ar gas) under at least atmospheric pressure. The second aging treatment may be performed under the same conditions as the first aging treatment except that the holding temperature may be 450° C. or more and 550° C. or less. The aging treatment can improve the magnetic properties of the R-T-B based permanent magnet. The aging treatment step may be carried out after the machining step described later.

### [Cooling Step]

After the aging treatment (the first aging treatment or the second aging treatment) of the R-T-B based permanent magnet, the R-T-B based permanent magnet is rapidly cooled in an inert gas atmosphere (cooling step). This can provide the R-T-B based permanent magnet according to the present embodiment. The cooling rate is not limited. The cooling rate may be 30° C./min or higher.

### [Machining Step]

The resultant R-T-B based permanent magnet may be machined into a desired shape as necessary (machining step). Examples of machining methods include shape machining (e.g., cutting or grinding) and chamfering (e.g., barrel polishing).

### [Grain Boundary Diffusion Step]

Further, a heavy rare earth element or elements may be diffused to the grain boundaries of the machined R-T-B based permanent magnet (grain boundary diffusion step). Methods of grain boundary diffusion are not limited. For example, a compound containing the heavy rare earth element or elements may adhere to a surface of the R-T-B based permanent magnet by coating, deposition, or the like, and then a heat treatment may be performed. Alternatively, the R-T-B based permanent magnet may be subject to a heat treatment in an atmosphere containing a vapor of the heavy rare earth element or elements. Grain boundary diffusion can further improve HcJ of the R-T-B based permanent magnet.

### [Surface Treatment Step]

The R-T-B based permanent magnet resulting from the above steps may be subject to surface treatments, such as plating, resin coating, an oxidizing treatment, and a chemical treatment (surface treatment step). This can further improve the corrosion resistance.

The R-T-B based permanent magnet resulting as above has good magnetic properties. That is, the R-T-B based permanent magnet has an improved Br at room temperature and an improved HcJ at high temperatures in a well-balanced manner. Specifically, the R-T-B based permanent magnet satisfies Br_{L}+ (HcJ_{H}/3)≥1580, where Br_{L} (mT) denotes Br of the R-T-B based permanent magnet at room temperature (23° C.) and HcJ_{H} (kA/m) denotes HcJ of the R-T-B based permanent magnet at high temperatures (150° C.).

The present disclosure is not limited to the above-mentioned embodiment and can variously be modified within the scope of the present disclosure. For example, regarding the method of manufacturing the R-T-B based permanent magnet, hot forming and hot working may be employed in place of sintering.

### EXAMPLES

Hereinafter, the present disclosure is described in further detail using examples.

However, the present disclosure is not limited to these examples.

### Experiment 1

### (Alloy Preparation Step)

In an alloy preparation step, a raw material alloy, with which an R-T-B based permanent magnet having a composition shown in Tables 1 to 3 was eventually produced, was prepared. “TRE” indicates an “R” content. The content of each element not described in Tables 1 to 3 other than Fe was less than 0.01 mass %. That is, Fe was substantially the balance in each Example or Comparative Example shown in Tables 1 to 3.

First, raw material metals containing predetermined elements were prepared. As the raw material metals, for example, simple substances of elements shown in Tables 1 to 3, alloys containing elements shown in Tables 1 to 3, and/or compounds containing elements shown in Tables 1 to 3 were selected as appropriate and prepared.

Then, these raw material metals were weighed, and a strip casting method was used to prepare the raw material alloy. At that time, the raw material alloy, with which the magnet having the composition shown in Tables 1 to 3 was eventually produced, was prepared. The carbon content of the raw material alloy was controlled by changing the proportion of pig iron used as a raw material metal.

### (Pulverization Step)

In a pulverization step, the raw material alloy resulting from the alloy preparation step was pulverized to provide an alloy powder. Pulverization was carried out in two steps, which were coarse pulverization and fine pulverization. Coarse pulverization was carried out using hydrogen storage pulverization. After the raw material alloy stored hydrogen, dehydrogenation was carried out in an argon flow or a vacuum at 300 to 600° C. Coarse pulverization gave an alloy powder having a particle size of about several hundred μm to about several mm.

Fine pulverization was carried out with a jet mill after oleic amide was added as a pulverization aid to 100 parts by mass alloy powder resulting from coarse pulverization and was mixed with the powder. The amount of oleic amide added was controlled so that the magnet eventually produced had the composition shown in Tables 1 to 3. For the jet mill, a nitrogen gas was used. Fine pulverization was carried out until the alloy powder had a D50 of about 3.0 μm.

### (Pressing Step)

In a pressing step, the alloy powder resulting from the pulverization step was pressed in a magnetic field to provide a green compact. After a mold disposed in an electromagnet was filled with the alloy powder, the powder was pressed while a magnetic field was applied using the electromagnet. The magnetic field applied was 1200 kA/m. The pressure applied during pressing was 40 MPa.

### (Sintering Step)

In a sintering step, the resultant green compact was sintered to provide a sintered body. The holding temperature and the holding time during sintering varied as appropriate according to the B content. Tables 1 to 3 show the holding temperature and the holding time during sintering. The heating rate to reach the holding temperature was 8.0° C./min. The cooling rate to cool from the holding temperature to room temperature was 50° C./min. The sintering atmosphere was a vacuum atmosphere or an inert gas atmosphere.

### (Aging Treatment Step)

In an aging treatment step, the resultant sintered body was subject to an aging treatment to provide the R-T-B based permanent magnet. The aging treatment was performed in two stages, which were a first aging treatment and a second aging treatment.

In the first aging treatment, the heating rate to reach the holding temperature was 8.0° C./min. The holding temperature was 900° C. The holding time was 1.0 hour. The cooling rate to cool from the holding temperature to room temperature was 50° C./min. The atmosphere of the first aging treatment was an Ar atmosphere.

In the second aging treatment, the heating rate to reach the holding temperature was 8.0° C./min. The holding temperature was 500° C. The holding time was 1.5 hours. The cooling rate to cool from the holding temperature to room temperature was 50° C./min. The atmosphere of the second aging treatment was an Ar atmosphere.

Through compositional analyses such as a fluorescence X-ray analysis, inductively coupled plasma emission spectroscopic analysis (ICP analysis), and a gas analysis, it was confirmed that the composition of the R-T-B based permanent magnet eventually produced in each Example or Comparative Example was as shown in Tables 1 to 3. In particular, the C content was measured using a combustion in an oxygen airflow-infrared absorption method. The B content was measured using ICP analysis.

### Evaluation

Magnetic properties of the R-T-B based permanent magnet formed from the raw material alloy of each Example or Comparative Example were measured using a B—H tracer. As the magnetic properties, Br_{L} and HcJ_{H} were measured. Further, Br_{L}+ (HcJ_{H}/3) was calculated. Tables 1 to 3 show the results.

The R-T-B based permanent magnet satisfying Br_{L}+ (HcJ_{H}/3)≥1580 was defined as good in Examples.

TABLE 1

| | TRE | Nd | Pr | Co | B | Al | Cu | Ga | Zr |
|---|---|---|---|---|---|---|---|---|---|
| | [mass %] | [mass %] | [mass %] | [mass %] | [mass %] | [mass %] | [mass %] | [mass %] | [mass %] |
| Example 1 | 32.00 | 25.44 | 6.56 | 2.00 | 0.75 | 0.02 | 0.30 | 0.80 | 0.50 |
| Example 2 | 32.00 | 25.44 | 6.56 | 2.00 | 0.78 | 0.02 | 0.30 | 0.80 | 0.50 |
| Example 3 | 32.00 | 25.44 | 6.56 | 2.00 | 0.83 | 0.02 | 0.30 | 0.80 | 0.50 |
| Example 4 | 32.00 | 25.44 | 6.56 | 0.88 | 0.88 | 0.02 | 0.15 | 0.60 | 0.50 |
| Comparative Example 1 | 32.00 | 25.44 | 6.56 | 0.88 | 0.90 | 0.02 | 0.15 | 0.60 | 0.50 |
| Example 5 | 32.00 | 25.44 | 6.56 | 2.00 | 0.7 | 0.03 | 0.30 | 0.80 | 0.50 |
| Example 6 | 32.00 | 25.44 | 6.56 | 2.00 | 0.78 | 0.03 | 0.30 | 0.80 | 0.50 |
| Example 7 | 32.00 | 25.44 | 6.56 | 2.00 | 0.83 | 0.03 | 0.30 | 0.80 | 0.50 |
| Example 8 | 32.00 | 25.44 | 6.56 | 0.80 | 0.88 | 0.03 | 0.15 | 0.60 | 0.50 |
| Comparative Example 2 | 32.00 | 25.44 | 6.56 | 0.80 | 0.90 | 0.03 | 0.15 | 0.60 | 0.50 |
| Comparative Example 3 | 32.00 | 25.44 | 6.56 | 2.00 | 0.60 | 0.05 | 0.30 | 0.80 | 0.50 |
| Example 9 | 32.00 | 25.44 | 6.56 | 2.00 | 0.70 | 0.05 | 0.30 | 0.80 | 0.50 |
| Example 10 | 32.00 | 25.44 | 6.56 | 2.00 | 0.75 | 0.05 | 0.30 | 0.80 | 0.50 |
| Example 11 | 32.00 | 25.44 | 6.56 | 2.00 | 0.78 | 0.05 | 0.30 | 0.80 | 0.50 |
| Example 12 | 32.00 | 25.44 | 6.56 | 2.00 | 0.83 | 0.05 | 0.30 | 0.80 | 0.50 |
| Example 13 | 32.00 | 25.44 | 6.56 | 0.88 | 0.88 | 0.05 | 0.15 | 0.60 | 0.50 |
| Comparative Example 4 | 32.00 | 25.44 | 6.56 | 0.88 | 0.90 | 0.05 | 0.15 | 0.60 | 0.50 |
| Example 14 | 32.00 | 25.44 | 6.56 | 2.00 | 0.75 | 0.07 | 0.30 | 0.80 | 0.50 |
| Example 15 | 32.00 | 25.44 | 6.56 | 2.00 | 0.78 | 0.07 | 0.30 | 0.80 | 0.50 |
| Example 16 | 32.00 | 25.44 | 6.56 | 2.00 | 0.83 | 0.07 | 0.30 | 0.80 | 0.50 |
| Example 17 | 32.00 | 25.44 | 6.56 | 0.88 | 0.88 | 0.07 | 0.15 | 0.60 | 0.50 |
| Comparative Example 5 | 32.00 | 25.44 | 6.56 | 0.88 | 0.90 | 0.07 | 0.15 | 0.60 | 0.50 |
| Comparative Example 6 | 32.00 | 25.44 | 6.56 | 2.00 | 0.75 | 0.08 | 0.30 | 0.80 | 0.50 |
| Comparative Example 7 | 32.00 | 25.44 | 6.56 | 2.00 | 0.78 | 0.08 | 0.30 | 0.80 | 0.50 |
| Comparative Example 8 | 32.00 | 25.44 | 6.56 | 2.00 | 0.83 | 0.08 | 0.30 | 0.80 | 0.50 |
| Comparative Example 9 | 32.00 | 25.44 | 6.56 | 0.88 | 0.88 | 0.08 | 0.15 | 0.60 | 0.50 |
| Comparative Example 10 | 32.00 | 25.44 | 6.56 | 0.88 | 0.90 | 0.08 | 0.15 | 0.60 | 0.50 |

| | | | | Holding | Holding | | | |
|---|---|---|---|---|---|---|---|---|
| | O | N | C | temperature | time | Br_{L} | HcJ_{H} | Br_{L}+ |
| | [mass %] | [mass %] | [mass %] | [° C.] | [h] | [mT] | [kA/m] | (HcJ_{H}/3) |
| Example 1 | 0.05 | 0.07 | 0.20 | 1040 | 40 | 1348 | 708 | 1584 |
| Example 2 | 0.05 | 0.07 | 0.17 | 1040 | 40 | 1351 | 698 | 1584 |
| Example 3 | 0.05 | 0.07 | 0.13 | 1060 | 8 | 1357 | 680 | 1584 |
| Example 4 | 0.05 | 0.07 | 0.09 | 1070 | 4 | 1388 | 583 | 1582 |
| Comparative Example 1 | 0.05 | 0.07 | 0.09 | 1070 | 4 | 1392 | 526 | 1567 |
| Example 5 | 0.05 | 0.07 | 0.20 | 1040 | 40 | 1346 | 710 | 1583 |
| Example 6 | 0.05 | 0.07 | 0.17 | 1040 | 10 | 1350 | 698 | 1583 |
| Example 7 | 0.05 | 0.07 | 0.13 | 1060 | 8 | 1356 | 681 | 1583 |
| Example 8 | 0.05 | 0.07 | 0.09 | 1070 | 4 | 1387 | 585 | 1582 |
| Comparative Example 2 | 0.05 | 0.07 | 0.09 | 1070 | 4 | 1390 | 527 | 1566 |
| Comparative Example 3 | 0.05 | 0.07 | 0.32 | 1020 | 10 | 1315 | 603 | 1516 |
| Example 9 | 0.05 | 0.07 | 0.25 | 1020 | 10 | 1338 | 727 | 1580 |
| Example 10 | 0.05 | 0.07 | 0.20 | 1040 | 40 | 1344 | 715 | 1582 |
| Example 11 | 0.05 | 0.07 | 0.17 | 1040 | 40 | 1348 | 702 | 1582 |
| Example 12 | 0.05 | 0.07 | 0.13 | 1060 | 8 | 1354 | 687 | 1583 |
| Example 13 | 0.05 | 0.07 | 0.09 | 1070 | 1 | 1385 | 591 | 1582 |
| Comparative Example 4 | 0.05 | 0.07 | 0.09 | 1070 | 4 | 1387 | 533 | 1565 |
| Example 14 | 0.05 | 0.07 | 0.20 | 1040 | 40 | 1342 | 718 | 1581 |
| Example 15 | 0.05 | 0.07 | 0.17 | 1040 | 40 | 1347 | 704 | 1582 |
| Example 16 | 0.05 | 0.07 | 0.13 | 1060 | 8 | 1352 | 692 | 1583 |
| Example 17 | 0.05 | 0.07 | 0.09 | 1070 | 4 | 1383 | 596 | 1582 |
| Comparative Example 5 | 0.05 | 0.07 | 0.09 | 1070 | 4 | 1384 | 535 | 1562 |
| Comparative Example 6 | 0.05 | 0.07 | 0.20 | 1040 | 40 | 1338 | 720 | 1578 |
| Comparative Example 7 | 0.05 | 0.07 | 0.17 | 1040 | 10 | 1344 | 706 | 1579 |
| Comparative Example 8 | 0.05 | 0.07 | 0.13 | 1060 | 8 | 1348 | 694 | 1579 |
| Comparative Example 9 | 0.05 | 0.07 | 0.09 | 1070 | 4 | 1379 | 597 | 1578 |
| Comparative Example 10 | 0.05 | 0.07 | 0.09 | 1070 | 4 | 1381 | 537 | 1560 |

TABLE 2

| | TRE | Nd | Pr | Co | B | Al | Cu | Ga | Zr |
|---|---|---|---|---|---|---|---|---|---|
| | [mass %] | [mass %] | [mass %] | [mass %] | [mass %] | [mass %] | [mass %] | [mass %] | [mass %] |
| Comparative Example 16 | 29.50 | 23.45 | 6.05 | 2.00 | 0.78 | 0.05 | 0.30 | 0.80 | 0.50 |
| Example 18 | 30.00 | 23.85 | 6.15 | 2.00 | 0.78 | 0.05 | 0.30 | 0.80 | 0.50 |
| Example 18a | 31.00 | 24.65 | 6.36 | 2.00 | 0.78 | 0.05 | 0.30 | 0.80 | 0.50 |
| Example b | 31.50 | 25.04 | 6.46 | 2.00 | 0.78 | 0.05 | 0.30 | 0.80 | 0.50 |
| Example 11 | 32.00 | 25.44 | 6.56 | 2.00 | 0.78 | 0.05 | 0.30 | 0.80 | 0.50 |
| Example 19 | 33.00 | 26.24 | 6.77 | 2.00 | 0.78 | 0.05 | 0.30 | 0.80 | 0.50 |
| Comparative Example 17 | 33.50 | 26.63 | 6.87 | 2.00 | 0.78 | 0.05 | 0.30 | 0.80 | 0.50 |
| Comparative Example 18 | 32.00 | 25.44 | 6.56 | 2.00 | 0.78 | 0.05 | 0.30 | 0.30 | 0.50 |
| Example 20 | 32.00 | 25.44 | 6.56 | 2.00 | 0.78 | 0.05 | 0.30 | 0.40 | 0.50 |
| Example 20a | 32.00 | 25.44 | 6.56 | 2.00 | 0.78 | 0.05 | 0.30 | 0.60 | 0.50 |
| Example 11 | 32.00 | 25.44 | 6.56 | 2.00 | 0.78 | 0.05 | 0.30 | 0.80 | 0.50 |
| Example 21 | 32.00 | 25.44 | 6.56 | 2.00 | 0.78 | 0.05 | 0.30 | 1.00 | 0.50 |
| Comparative Example 19 | 32.00 | 25.44 | 6.56 | 2.00 | 0.78 | 0.05 | 0.30 | 1.20 | 0.50 |
| Comparative Example 20 | 32.00 | 25.44 | 6.56 | 2.00 | 0.78 | 0.05 | 0.30 | 0.80 | 0.10 |
| Example 22 | 32.00 | 25.44 | 6.56 | 2.00 | 0.78 | 0.05 | 0.30 | 0.80 | 0.15 |
| Example 23 | 32.00 | 25.44 | 6.56 | 2.00 | 0.78 | 0.05 | 0.30 | 0.80 | 0.35 |
| Example 22 | 32.00 | 25.44 | 6.56 | 2.00 | 0.78 | 0.05 | 0.30 | 0.80 | 0.50 |
| Example 24 | 32.00 | 25.44 | 6.56 | 2.00 | 0.78 | 0.05 | 0.30 | 0.80 | 0.95 |
| Example 25 | 32.00 | 25.44 | 6.56 | 2.00 | 0.78 | 0.05 | 0.30 | 0.80 | 1.30 |
| Example 26 | 32.00 | 25.44 | 6.56 | 2.00 | 0.78 | 0.05 | 0.30 | 0.80 | 1.50 |
| Comparative Example 21 | 32.00 | 25.44 | 6.56 | 2.00 | 0.78 | 0.05 | 0.30 | 0.80 | 1.70 |
| Example 27 | 32.00 | 25.44 | 6.56 | 2.00 | 0.78 | 0.05 | 0.15 | 0.80 | 0.50 |
| Example 27a | 32.00 | 25.44 | 6.56 | 2.00 | 0.78 | 0.05 | 0.20 | 0.80 | 0.50 |
| Example 11 | 32.00 | 25.44 | 6.56 | 2.00 | 0.78 | 0.05 | 0.30 | 0.80 | 0.50 |
| Example 28 | 32.00 | 25.44 | 6.56 | 2.00 | 0.78 | 0.05 | 1.00 | 0.80 | 0.50 |
| Example 8 | 32.00 | 25.44 | 6.56 | 0.80 | 0.88 | 0.03 | 0.15 | 0.60 | 0.50 |
| Example 29 | 32.00 | 25.44 | 6.56 | 0.88 | 0.88 | 0.03 | 0.30 | 0.60 | 0.50 |
| Example 30 | 32.00 | 25.44 | 6.56 | 1.25 | 0.88 | 0.03 | 0.30 | 0.60 | 0.50 |
| Example 31 | 32.00 | 25.44 | 6.56 | 1.63 | 0.88 | 0.03 | 0.30 | 0.60 | 0.50 |
| Example 32 | 32.00 | 25.44 | 6.56 | 2.00 | 0.88 | 0.03 | 0.30 | 0.60 | 0.50 |
| Example 33 | 32.00 | 25.44 | 6.56 | 3.00 | 0.88 | 0.03 | 0.30 | 0.60 | 0.50 |

| | | | | Holding | Holding | | | |
|---|---|---|---|---|---|---|---|---|
| | O | N | C | temperature | time | Br_{L} | HcJ_{H} | Br_{L}+ |
| | [mass %] | [mass %] | [mass %] | [° C.] | [h] | [m]] | [kA/m] | (HcJ_{H}/3) |
| Comparative Example 16 | 0.05 | 0.07 | 0.17 | 1040 | 40 | 1392 | 535 | 1570 |
| Example 18 | 0.05 | 0.07 | 0.17 | 1040 | 40 | 1386 | 595 | 1584 |
| Example 18a | 0.05 | 0.07 | 0.17 | 1040 | 40 | 1371 | 641 | 1585 |
| Example b | 0.05 | 0.07 | 0.17 | 1040 | 40 | 1360 | 669 | 1583 |
| Example 11 | 0.05 | 0.07 | 0.17 | 1040 | 40 | 1348 | 702 | 1582 |
| Example 19 | 0.05 | 0.07 | 0.17 | 1040 | 40 | 1334 | 739 | 1580 |
| Comparative Example 17 | 0.05 | 0.07 | 0.17 | 1040 | 40 | 1328 | 742 | 1575 |
| Comparative Example 18 | 0.05 | 0.07 | 0.17 | 1040 | 40 | 1369 | 587 | 1565 |
| Example 20 | 0.05 | 0.07 | 0.17 | 1040 | 40 | 1368 | 644 | 1583 |
| Example 20a | 0.05 | 0.07 | 0.17 | 1040 | 40 | 1359 | 669 | 1582 |
| Example 11 | 0.05 | 0.07 | 0.17 | 1040 | 40 | 1348 | 702 | 1582 |
| Example 21 | 0.05 | 0.07 | 0.17 | 1040 | 40 | 1340 | 722 | 1581 |
| Comparative Example 19 | 0.05 | 0.07 | 0.17 | 1040 | 40 | 1333 | 700 | 1566 |
| Comparative Example 20 | 0.05 | 0.07 | 0.12 | 1040 | 40 | 1353 | 632 | 1564 |
| Example 22 | 0.05 | 0.07 | 0.14 | 1040 | 40 | 1353 | 697 | 1585 |
| Example 23 | 0.05 | 0.07 | 0.15 | 1040 | 10 | 1350 | 700 | 1583 |
| Example 22 | 0.05 | 0.07 | 0.17 | 1040 | 40 | 1348 | 702 | 1582 |
| Example 24 | 0.05 | 0.07 | 0.21 | 1040 | 40 | 1344 | 712 | 1581 |
| Example 25 | 0.05 | 0.07 | 0.24 | 1040 | 40 | 1342 | 718 | 1581 |
| Example 26 | 0.05 | 0.07 | 0.26 | 1040 | 40 | 1338 | 726 | 1580 |
| Comparative Example 21 | 0.05 | 0.07 | 0.28 | 1040 | 40 | 1318 | 649 | 1534 |
| Example 27 | 0.05 | 0.07 | 0.17 | 1040 | 40 | 1348 | 700 | 1581 |
| Example 27a | 0.05 | 0.07 | 0.17 | 1040 | 40 | 1348 | 703 | 1582 |
| Example 11 | 0.05 | 0.07 | 0.17 | 1040 | 40 | 1348 | 702 | 1582 |
| Example 28 | 0.05 | 0.07 | 0.17 | 1040 | 40 | 1357 | 698 | 1590 |
| Example 8 | 0.05 | 0.07 | 0.09 | 1070 | 4 | 1387 | 585 | 1582 |
| Example 29 | 0.05 | 0.07 | 0.09 | 1070 | 4 | 1385 | 591 | 1582 |
| Example 30 | 0.05 | 0.07 | 0.09 | 1070 | 4 | 1393 | 585 | 1588 |
| Example 31 | 0.05 | 0.07 | 0.09 | 1070 | 4 | 1397 | 581 | 1591 |
| Example 32 | 0.05 | 0.07 | 0.09 | 1070 | 4 | 1400 | 562 | 1587 |
| Example 33 | 0.05 | 0.07 | 0.09 | 1070 | 4 | 1408 | 528 | 1584 |

TABLE 3

| | TRE | Nd | Pr | Dy | Tb | Co | B | Al | Cu | Ga |
|---|---|---|---|---|---|---|---|---|---|---|
| | [mass %] | [mass %] | [mass %] | [mass %] | [mass %] | [mass %] | [mass %] | [mass %] | [mass %] | [mass %] |
| Example 11 | 32.00 | 25.44 | 6.56 | 0.00 | 0.00 | 2.00 | 0.78 | 0.05 | 0.30 | 0.80 |
| Example 34 | 32.00 | 25.12 | 6.48 | 0.00 | 0.40 | 2.00 | 0.78 | 0.05 | 0.30 | 0.80 |
| Example 35 | 32.00 | 24.80 | 6.40 | 0.00 | 0.80 | 2.00 | 0.78 | 0.05 | 0.30 | 0.80 |
| Example 36 | 32.00 | 25.12 | 6.48 | 0.40 | 0.00 | 2.00 | 0.78 | 0.05 | 0.30 | 0.80 |
| Example 37 | 32.00 | 24.80 | 6.40 | 0.80 | 0.00 | 2.00 | 0.78 | 0.05 | 0.30 | 0.80 |
| Comparative Example 4 | 32.00 | 25.44 | 6.56 | 0.00 | 0.00 | 0.88 | 0.90 | 0.05 | 0.15 | 0.60 |
| Comparative Example 22 | 32.00 | 25.12 | 6.48 | 0.00 | 0.40 | 0.88 | 0.90 | 0.05 | 0.15 | 0.60 |
| Comparative Example 23 | 32.00 | 24.80 | 6.40 | 0.00 | 0.80 | 0.88 | 0.90 | 0.05 | 0.15 | 0.60 |
| Comparative Example 24 | 32.00 | 25.12 | 6.48 | 0.40 | 0.00 | 0.88 | 0.90 | 0.05 | 0.15 | 0.60 |
| Comparative Example 25 | 32.00 | 24.80 | 6.40 | 0.80 | 0.00 | 0.88 | 0.90 | 0.05 | 0.15 | 0.60 |
| Example 15 | 32.00 | 25.44 | 6.56 | 0.00 | 0.00 | 2.00 | 0.78 | 0.07 | 0.30 | 0.80 |
| Example 38 | 32.00 | 25.12 | 6.48 | 0.00 | 0.40 | 2.00 | 0.78 | 0.07 | 0.30 | 0.80 |
| Example 39 | 32.00 | 24.80 | 6.40 | 0.00 | 0.80 | 2.00 | 0.78 | 0.07 | 0.30 | 0.80 |
| Example 40 | 32.00 | 25.12 | 6.48 | 0.40 | 0.00 | 2.00 | 0.78 | 0.07 | 0.30 | 0.80 |
| Example 41 | 32.00 | 24.80 | 6.40 | 0.80 | 0.00 | 2.00 | 0.78 | 0.07 | 0.30 | 0.80 |

| | | | | | Holding | Holding | | | |
|---|---|---|---|---|---|---|---|---|---|
| | Zr | O | N | C | temperature | time | Br_{L} | HcJ_{H} | Br_{L}+ |
| | [mass %] | [mass %] | [mass %] | [mass %] | [° C.] | [h] | [mT] | [kA/m] | (HcJ_{H}/3) |
| Example 11 | 0.50 | 0.05 | 0.07 | 0.17 | 1040 | 40 | 1348 | 702 | 1582 |
| Example 34 | 0.50 | 0.05 | 0.07 | 0.17 | 1040 | 40 | 1346 | 738 | 1592 |
| Example 35 | 0.50 | 0.05 | 0.07 | 0.17 | 1040 | 40 | 1342 | 784 | 1603 |
| Example 36 | 0.50 | 0.05 | 0.07 | 0.17 | 1040 | 40 | 1340 | 754 | 1591 |
| Example 37 | 0.50 | 0.05 | 0.07 | 0.17 | 1040 | 40 | 1327 | 782 | 1588 |
| Comparative Example 4 | 0.50 | 0.05 | 0.07 | 0.09 | 1070 | 4 | 1387 | 533 | 1565 |
| Comparative Example 22 | 0.50 | 0.05 | 0.07 | 0.09 | 1070 | 4 | 1382 | 562 | 1569 |
| Comparative Example 23 | 0.50 | 0.05 | 0.07 | 0.09 | 1070 | 4 | 1375 | 602 | 1576 |
| Comparative Example 24 | 0.50 | 0.05 | 0.07 | 0.09 | 1070 | 4 | 1368 | 578 | 1561 |
| Comparative Example 25 | 0.50 | 0.05 | 0.07 | 0.09 | 1070 | 4 | 1356 | 604 | 1557 |
| Example 15 | 0.50 | 0.05 | 0.07 | 0.17 | 1040 | 40 | 1347 | 704 | 1582 |
| Example 38 | 0.50 | 0.05 | 0.07 | 0.17 | 1040 | 40 | 1340 | 740 | 1587 |
| Example 39 | 0.50 | 0.05 | 0.07 | 0.17 | 1040 | 40 | 1336 | 783 | 1597 |
| Example 40 | 0.50 | 0.05 | 0.07 | 0.17 | 1040 | 40 | 1335 | 751 | 1585 |
| Example 41 | 0.50 | 0.05 | 0.07 | 0.17 | 1040 | 40 | 1322 | 779 | 1582 |

Table 1 shows Examples and Comparative Examples mainly having variation of the B content and the Al content. Each Example having a B content of 0.70 mass % or more and 0.88 mass % or less and an Al content of above 0 and 0.07 mass % or less satisfied Br_{L}+ (HcJ_{H}/3)≥1580. By contrast, in Comparative Example 3 having too low a B content, sintering did not sufficiently proceed. As a result, Comparative Example 3 did not satisfy Br_{L}+ (HcJ_{H}/3)≥1580. Each Comparative Example having too high a B content did not satisfy Br_{L}+ (HcJ_{H}/3)≥1580. Each Comparative Example having too high an Al content did not satisfy Br_{L}+ (HcJ_{H}/3)≥1580.

Table 2 shows Examples and Comparative Examples mainly having variation of the “R” content (TRE), the Ga content, the Zr content, the Cu content, or the Co content. Each Example having the content of all the elements within predetermined ranges satisfied Br_{L}+ (HcJ_{H}/3)≥1580. By contrast, each Comparative Example having the “R” content (TRE), the Ga content, or the Zr content out of the predetermined ranges did not satisfy Br_{L}+ (HcJ_{H}/3)≥1580.

Table 3 shows Examples and Comparative Examples having Nd or Pr partly substituted by Dy or Tb with the ratios of Nd to Pr of Example 11, Comparative Example 4, and Example 15 being unchanged. Even when Nd or Pr was partly substituted by Dy or Tb, each Example having the content of all the elements within predetermined ranges satisfied Br_{L}+ (HcJ_{H}/3)≥1580. By contrast, each Comparative Example having a B content out of a predetermined range did not satisfy Br_{L}+ (HcJ_{H}/3)≥1580.

1. An R-T-B based permanent magnet comprising Al, Ga, and Zr and having
an R content of 30.00 mass % or more and 33.00 mass % or less,
a B content of 0.70 mass % or more and 0.88 mass % or less,
an Al content of above 0 mass % and 0.07 mass % or less,
a Ga content of 0.40 mass % or more and 1.00 mass % or less, and
a Zr content of above 0.10 mass % and 1.60 mass % or less,
out of 100 mass % of the R-T-B based permanent magnet.

2. The R-T-B based permanent magnet according to claim 1 having a Co content of 0.50 mass % or more and 3.00 mass % or less.

3. The R-T-B based permanent magnet according to claim 1, having a Cu content of 0.15 mass % or more and 1.00 mass % or less.

4. The R-T-B based permanent magnet according to claim 1, having a C content of 0.05 mass % or more and 0.30 mass % or less.

5. The R-T-B based permanent magnet according to claim 1, having a heavy rare earth element content of 0 mass % or more and 0.30 mass % or less.

6. The R-T-B based permanent magnet according to claim 1, satisfying Br_{L}+ (HcJ_{H}/3)≥1580, where Br_{L} (mT) denotes a residual flux density of the R-T-B based permanent magnet at room temperature and HcJ_{H} (kA/m) denotes a coercivity of the R-T-B based permanent magnet at 150° C.
